(19) United States
(12) Patent Application Publication
(10) Pub. No.: US 2003/0037415 A1
(43) Pub. Date: Feb. 27, 2003

(54) Process for the production of granules in a circulating fluidized bed,, apparatus for the performance of the process and granules obtained in accordance with the process

(75) Inventors: Hans Christian Alt, Gelnhausen (DE); Andreas Geisselmann, Frankfurt (DE); Natalia Hinrichs, Alzenau (DE); Hermanus Gerhardus Jozef Lansink Rotgerink, Mombris (DE)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: DEGUSSA AG, Duesseldorf (DE)

(21) Appl. No.: 10/188,113

(22) Filed: Jul. 3, 2002

(30) Foreign Application Priority Data
Jul. 3, 2001 (DE) 101 32 177.5

(51) Int. Cl. B01J 35/08

(52) U.S. Cl. 23/293 R; 502/9; 264/14

(57) ABSTRACT

A continuous process and apparatus for the production of at least approximately spherical, substantially solid particles, in which the particles are granulated in a circulating fluidized bed. This can be achieved by spraying a suspension or a solution of the solid which forms the particles into a chamber. A drying gas is passed through the chamber at a velocity which is sufficient to effect pneumatic conveying of already partially dried or agglomerated particles. The particles conveyed by the drying gas stream are separated from the exhaust gas stream and returned, at least in part, to the chamber. Particles with a size within the desired particle size range are continuously discharged from the chamber, such that the mass present in the chamber remains constant.

### CROSS-REFERENCE TO RELATED APPLICATION

This application claims priority to German application no. 101 32 177.5, filed Jul. 3, 2001, the disclosure of which is incorporated by reference herein in its entirety.

### BACKGROUND OF THE INVENTION

1. Field of the Invention

The invention relates to the performance of granulation in a circulating fluidized bed.

2. Description of the Related Art

Known drying processes which impart shape, such as spray drying, fluidized bed spray granulation or fluidized bed agglomeration, are used to convert liquids, such as suspensions, solutions and melts, into solid products of commerce. These processes give rise to more or less spherical granules or agglomerates.

Increasingly stringent requirements are being placed upon the granules or agglomerates with regard to their bulk material properties. The resultant products should, for example, be dust-free and readily flowable and should also exhibit a narrow grain size distribution and the highest possible bulk density.

From F. V. Shaw “Role of Spray Drying in Production of Catalysts and Catalyst Supports”, American Chemical Society New York City Meeting, Aug. 25-30, 1991, it is known that, while conventional spray drying processes can indeed yield virtually spherical particles, hollow spheres or rings are, however, frequently formed. These are less stable than solid particles, as a result of which abrasion and consequently unwanted dusting occur during handling. Moreover, bulk density is reduced by such hollow structures.

The particle size distribution may be varied within limits by the selection and adjustment of the atomization means. Depending upon the atomization means used, a wider or narrower particle size distribution is obtained. The particle size distribution is also always dependent upon the properties of the products used. The minimum possible grain size is determined by the performance of the atomization means and is typically in the range from approximately 5-10 μm. The maximum possible drying time, which is determined by the size/geometry of the spray dryer, provides an upper limit to the size of the spray droplet which is still able to be dried (approximately 500 μm). A dust fraction must also always be anticipated due to the width of the grain size distribution.

Approximately spherical, solid particles may be produced for a wide range of applications by the known fluidized bed spray granulation process. Hans Uhlemann, Chem.-Ing.-Tech. 62 (1990) pp. 822-834, provides an overview of known processes and apparatuses for continuous fluidized bed spray granulation. One essential feature of fluidized bed spray granulation is the formation of a stable fluidized bed within the granulator. This means that the velocity of the fluidizing medium must be selected such that the particles to be dried are fluidized, but not pneumatically conveyed. In this manner, it is ensured that none of the particles formed are discharged, but are maintained in permanent motion, so achieving a constant probability of droplet collision. In conventional processes, the proportion of discharged and possibly returned fines is less than 10 times the mass constantly present in the granulator (hold-up) per hour. The discharged fines may be separated from the exhaust air and reintroduced into the granulator as nuclei. Achievable particle sizes are in the range from approximately 300 μm to approximately 30 mm. If this process is operated with an integral pneumatic classifier, the resultant grain size distribution is also more narrow and free of fines.

The lower limit of particle size is substantially determined by material properties, such as solid density, stickiness and fluidizing behavior. Furthermore, very fine particles can be fluidized only at very low velocity if they are not to be discharged from the granulator. Because, in this process, the fluidizing medium is the energy input medium, performance declines dramatically. As a result, the achievable accretion rates become so low that the granulation process can no longer be operated economically.

The known fluidized bed agglomeration process is generally the combination of spray drying and fluidized bed. The incompletely dried spray jet is intercepted by a drying fluidized bed. The stickiness of the still moist solid causes the individual particles to combine into agglomerates which grow and dry rover the course of the process. The process can be controlled by the fluidized bed operating parameters and the residual moisture content of the partially dried spray jet.

The possible grain size range for the particles produced by this process is approximately 0.2 to 3.0 mm. Very irregularly shaped agglomerates with a very wide grain size distribution are obtained. The agglomerates are not very dense but are dust-free and very readily soluble or dispersible.

### BRIEF SUMMARY OF THE INVENTION

The present invention advantageously provides a process to produce approximately spherical, solid particles with a narrow particle size distribution within the particle size range smaller than 100 μm from a solids suspension or solution of a relatively low concentration. This can be achieved, for example, by a continuous process for the production of at least approximately spherical, substantially solid particles, in which the particles are granulated in a circulating fluidized bed.

An example of an embodiment of the present invention relates to a process in which

a) a suspension or a solution of the solid which forms the particles is sprayed into a chamber,

b) a drying gas is passed through the chamber at a velocity which is sufficient to effect pneumatic conveying of already partially dried or agglomerated particles,

c) the particles conveyed by the drying gas stream are separated from the exhaust gas stream,

d) the particles separated from the exhaust gas stream are at least in part returned to the chamber, and

e) particles with a size within the desired particle size range are continuously discharged from the chamber, such that the mass present in the chamber remains constant.

The drying gas advantageously flows through the chamber contrary to the force of gravity and is introduced into the chamber via a distributor base plate.

In contrast with the known fluidized bed spray granulation process, it is not a stationary fluidized bed which is formed by the above-described process, but instead a circulating fluidized bed (CFB). The flow velocity of the drying gas stream is selected such that it is above the limit value at which the transition from a stable fluidized bed to pneumatic conveying occurs. This means that the fluidization velocity of the gas stream is set at a level such that a considerable proportion of the solid mass leaves the granulator through the top, wherein it is separated from the gas stream and returned to the granulator. The fluidization velocity is preferably 2-10 times, and, more preferably 3-6 times, the velocity which is required to discharge particles of the desired particle size with the drying gas stream.

It has been found that, in contrast with known fluidized bed spray granulation processes, it is possible with the process according to the invention to achieve elevated accretion rates, and also to obtain particles in the size range smaller than 100 μm, by means of spray granulation.

The solid may comprise an inorganic or organic material or a mixture of two or more such materials, optionally with addition of one or more additional binders or other auxiliary substances. It preferably comprises an inorganic oxide or a mixture of two or more inorganic oxides. The inorganic oxides can be selected from the following group: Al₂O₃, SiO₂, TiO₂, ZrO₂, Nb₂O₅, zeolites, and aluminosilicates. In a preferred embodiment of the invention, water can be used as the suspending medium.

According to another preferred embodiment, once separated, the particles are calcined at 100-1200° C.

The dried and optionally calcined particles produced in this manner are very particularly suitable for use as catalyst supports in processes performed in fluidized beds or in suspension, in particular in olefin polymerization.

The present invention can also provide an apparatus for the performance of the process according to the invention, which apparatus exhibits the following features:

a) a granulator chamber (1) having a diameter and a height, a ratio of the diameter to the height being from about 1:1 to about 1:5;

b) a distributor base plate disposed in the granulator chamber, the distributor base plate adapted for deposition thereon of the solid particles from the material;

c) atomizing means disposed in the chamber, the atomizing means adapted to atomize the suspension or solution;

d) feeding means to provide the suspension or solution to the atomizing device;

e) feeding means adapted to provide a fluidization and drying medium to the chamber;

f) a solids separation system (2) connected to the upper part of the granulation chamber via an opening in the chamber, the solids separation system adapted to separate a portion of the solid particles;

g) a return connected with the solid separation system and the lower portion of the chamber, the return adapted to return the separated portion of the solid particles to the chamber; and

h) optionally, a pneumatic classifier (3) which is mounted on the lower part of the chamber.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 shows a schematic diagram of an apparatus for performing granulation in a circulating fluidized bed.

### DESCRIPTION OF THE PREFERRED EMBODIMENTS

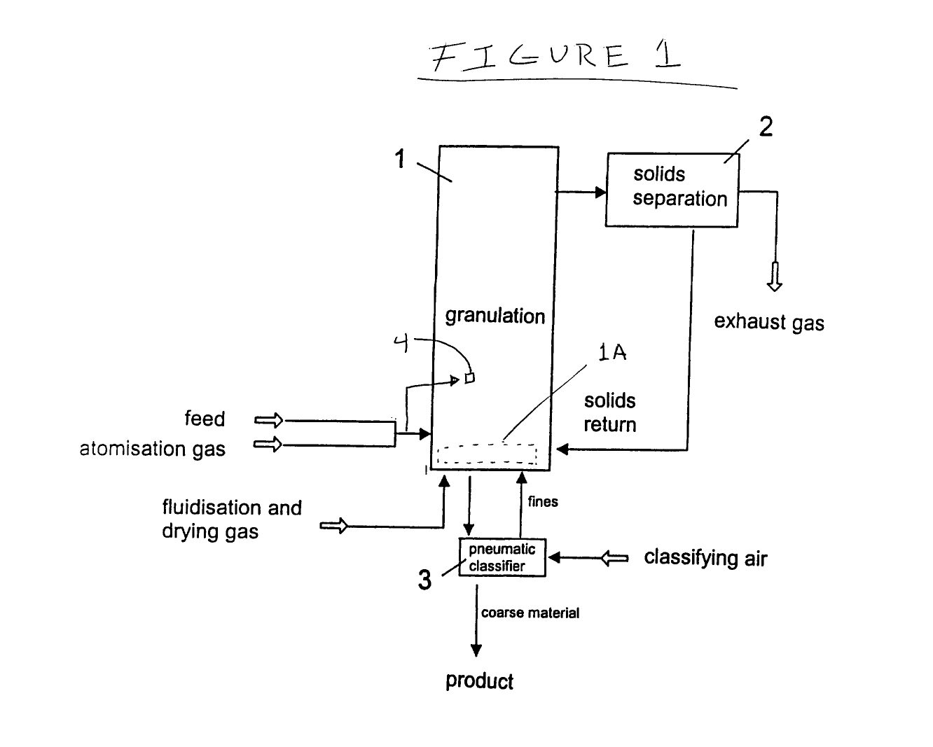

An example of the apparatus according to the invention, in which the process according to the invention can be performed, is shown in FIG. 1.

The apparatus includes a preferably cylindrical and tall granulation chamber 1 with a diameter:height ratio of 1:1 to 1:5, preferably of 1:2.5. The chamber is provided with a suitable distributor base plate 1A at its lower end. The pressure drop of the base plate can be calculated such that the fluidizing medium is uniformly distributed over the complete cross-section of the apparatus and there are no dead zones. After a further cylindrical portion, an exhaust duct of the granulator opens into the separation system 2, for example via one or more separation cyclones that are connected in series and an exhaust gas filter, into an exhaust gas stack. Solids separators are provided with solids return lines into the granulation chamber just above the distributor base plate. Suitable apparatuses, such as for example star wheel valves, are used to provide a pneumatic seal for the solids separator. The granulation chamber is supplied with hot drying gas (for example, flue gas, air, nitrogen) via a blower and a suitable gas heater.

A classifying discharge pipe 3, which can be one or more of many different shapes, is preferably fitted to a center of a lower end of the granulation chamber and opens into a recess in the distributor base plate. It can be provided with internal fittings to enhance classifying performance or be connected to a classifying chamber. A defined classifying upflow can be provided in the classifying pipe by a gas supply that is independent from the main stream. The solid can be discharged contrary to this flow via another pneumatic seal.

In order to produce approximately spherical particles, it is advantageous to break the suspension or solution down into very fine droplets within atomizing means 4. Pneumatic nozzles and pressure nozzles can be used to atomize the suspension or solution. A combined two-fluid nozzle is preferably used, wherein the suspension is conveyed to the nozzle via a multistage, low-pulsation, high pressure pump. A three-fluid or multifluid nozzle can also be used. The pressure setting of this nozzle can be calculated such that an elevated pressure drop is achieved at the flow rates under operating conditions. In order to obtain a very fine spray, an additional two-fluid atomization is superimposed on the pressure atomization.

The nozzle is preferably located at the bottom centrally in the middle above the distributor base plate and above the pneumatic classifier orifice with the spray directed upwards. The nozzle jet and thus the aperture angle may be adjusted with an adjustable air cap.

Solids granulation in the circulating fluidized bed (CFB) proceeds in the manner described below. The fluidization velocity of the hot drying gas in the granulation chamber is distinctly above the discharge velocity of the particles to be produced.

Using the nozzle, a solids-containing suspension or solution is sprayed into the granulation chamber which is operated with hot drying gas, but as yet still contains no solids. Here, the liquid vaporizes, leaving behind solids. The stream of particles formed in the granulation chamber is completely discharged from the chamber and is separated, for example using cyclones, and recycled into the chamber. This preferably occurs at a very high circulation rate. Preferred circulation rates are 10-1000 times, and more preferably 100-1000 times, the mass hold-up in the granulator per hour.

In order to ensure the presence of sufficient spray nuclei to absorb the suspension droplets in this circulating mass, an adequate mass hold-up is maintained in the system, which corresponds with an elevated circulating mass flow. The design of the solids separation of the exhaust gas stream is adapted to this elevated throughput.

A pressure drop measurement, for example over the first cyclone, can be used as a measure of the circulating mass flow. At higher solids loadings, the pressure drop over the cyclone increases under otherwise identical operating conditions. If the cyclone is overloaded and strikes through, the pressure differential then reaches a maximum which rises no further. The desired operating level is below this.

The recycled solids are conveyed upwards past the nozzle in the upflow of the drying chamber. Solids particles and spray droplets collide in the nozzle jet. The liquid dries on the surface of the particles, leaving the resultant solid behind. In this manner, the particles grow in the circulating layer. In order to obtain optimally spherical granules, the spray droplets are substantially smaller than the circulated granules.

The circulating mass is kept constant, such that, once a sufficient mass hold-up has built up in the granulator, a proportion of the mass contained therein is continuously discharged. By decreasing the gas stream in the integral pneumatic classifier, only the coarse particles are discharged and the fines remain in the granulator for further granule accretion. The pneumatic classifier is set such that the mass circulating the system remains constant.

The grain size to be achieved in the discharge is dependent upon the nucleus balance in the granulator. This is substantially determined by the equilibrium between nucleus formation due to abrasion or non-colliding spray droplets and granule accretion. Grain size can purposefully be increased by selection of the drying parameters or, alternatively, by the addition of binders.

Different drying parameters can accordingly be established by increasing the feed quantity. This brings about a reduction in exhaust gas temperature and more spray droplets are produced which dry more slowly. This increases the probability of collision with the granule nuclei and, in addition, the granule surface remains moist for longer. On average, larger nuclei are formed.

Addition of binders increases granule strength and thereby reduces abrasion. This results in the formation of fewer nuclei. In turn, the average grain size of the granules increases.

The process according to the invention can be complemented by product drying integrated into the process.

The present invention is explained in more detail with the aid of the following examples.

### EXAMPLE 1

An aqueous suspension containing 10 wt. % of AEROSIL380 is atomized in the apparatus according to the invention. The settings of feed air volumetric flow rate 500 m_{N}³/h, feed air temperature 230° C. and suspension mass flow rate 60 kg/h give rise to a particle size distribution with d₁₀=25 μm, d₅₀=50 μm, and d₉₀=75 μm.

### EXAMPLE 2

An aqueous suspension containing 5 wt. % of AEROSIL 300 and approx. 5 wt. % of 200 is atomized in the apparatus according to the invention. The settings of feed air volumetric flow rate 500 m_{N}³/h, feed air temperature 230° C., and suspension mass flow rate 65 kg/h give rise to a particle size distribution with d₁₀=35 μm, d₅₀=60 μm, and d₉₀=95 μm.

### EXAMPLE 3

An aqueous suspension containing 10 wt. % of AEROSIL 300 and 0.6 wt. % of titanium dioxide P 25 is atomized in the apparatus according to the invention. The settings of feed air volumetric flow rate 900 m_{N}³/h, feed air temperature 135° C., and suspension mass flow rate 60 kg/h give rise to a particle size distribution with d₁₀=45 μm, d₅₀=75 μm, and d₉₀=120 μm.

### EXAMPLE 4

An aqueous suspension containing 10 wt. % of AEROSIL 300 and 0.05 wt. % of is atomized in the apparatus according to the invention. The settings of feed air volumetric flow rate 500 m_{N}³/h, feed air temperature 300° C., and suspension mass flow rate 75 kg/h give rise to a particle size distribution with d₁₀=55 μm, d₅₀=85 μm, and d₉₀=145 μm.

### EXAMPLE 5a

### Preparation of a Polymerization Catalyst

The particles described in Example 1 are treated under nitrogen for 6 hours at 500° C. Using these particles as catalyst support, a catalyst is prepared in accordance with the method described in U.S. Pat. No. 4,427,573.

### EXAMPLE 5b

### Polymerization of Ethene

Polymerization is performed in suspension (suspending medium 250 ml of EC 180) at 70° C. and an ethylene pressure of 6 bar with the addition of 0.9 ml of 1M solution of triethylaluminium in hexane. The quantity of catalyst is calculated such that 0.0055 nmol of titanium are present in the reactor.

Obviously, numerous additional modifications and variations of the present invention are possible in light of the above teachings. It is therefore to be understood that within the scope of the appended claims, the present invention may be practiced otherwise than as specifically described herein.

What we claim is:

1. A continuous process for a production of approximately spherical, substantially solid particles, comprising:
granulating the particles in a circulating fluidized bed.

2. The process according to claim 1, comprising the steps of:
spraying a material into a chamber, the material including at least one of a suspension that has a suspension agent and a solid and a solution that has a solvent and the solid;
passing a drying gas stream through the chamber at a fluidization rate which is sufficient to effect pneumatic conveying of already partially dried or agglomerated particles; separating the particles conveyed by the drying gas stream from an exhaust gas stream; returning a portion of the separated particles to the chamber; and
continuously discharging particles having a size within a predetermined particle size range from the chamber at a discharge rate such that a mass present in the chamber remains constant.

3. The process according to claim 2, wherein the drying gas stream is passed through the chamber against a force of gravity, and is introduced into the chamber via a distributor base plate.

4. The process according to claim 2, wherein the flow velocity of the drying gas is greater than a velocity at which a transition from a stable fluidized bed to pneumatic conveying occurs.

5. The process according to claim 1, wherein the particles are continuously discharged by the drying gas stream having a higher flow velocity than being necessary to discharge particles out of the reactor.

6. The process according to claim 5, wherein the flow velocity of the drying gas is from about 2 to about 10 times higher than the minimum velocity necessary to discharge the particles out of the reactor.

7. The process according to claim 1, wherein a portion of the particles having the desired particle size are continuously discharged via a classifier stream that is independent of the drying gas stream.

8. The process according claim 1, wherein the solid comprises at least one of an inorganic oxide or mixtures of several inorganic oxides, optionally together with additional binders and/or organic substances.

9. The process according to claim 8, wherein the inorganic oxides are selected from the group consisting of Al₂O₃, SiO₂, TiO₂, ZrO₂, Nb₂O₅, zeolites and aluminosilicates.

10. The process according to claim 1, wherein the suspending agent or solvent is water.

11. The process according to claim 1, further comprising:
calcinating the separated particles at a temperature of from about 100 to about 1200° C.

12. Particles produced by a process of spraying at least one of a suspension including a suspension agent and a solid or a solution including a solvent and a solid into a chamber, passing a drying gas stream through the chamber at a fluidization velocity which is sufficient to effect pneumatic conveying of already partially dried or agglomerated particles, separating the particles conveyed by the drying gas stream from an exhaust gas stream, returning at least a part of the particles separated from the exhaust gas stream to the chamber, and continuously discharging the particles with a size within a desired particle size range from the chamber such that a mass present in the chamber remains constant.

13. The particles according to claim 12, wherein the particles have a particle size that is smaller than 100 μm.

14. An apparatus for producing approximately spherical, substantially solid particles from a material including at least one of a suspension with a suspension agent and a solid or a solution with a solvent and a solid, comprising:
a) a granulator chamber having a diameter and a height, a ratio of the diameter to the height being from about 1:1 to about 1:5;
b) a distributor base plate disposed in the granulator chamber, the distributor base plate adapted for deposition thereon of the solid particles from the material;
c) an atomizer disposed in the chamber and configured to atomize the suspension or solution;
d) a feeder configured to feed the suspension or solution to the atomizer;
e) a feeder configured to feed a fluidization and drying medium to the chamber;
f) a solids separation system connected to the upper part of the granulation chamber via an opening in the chamber and configured to separate a portion of the solid particles; and
g) a return connected with the solid separation system and the lower portion of the chamber and configured to return the separated portion of the solid particles to the chamber.

15. The apparatus of claim 14, further comprising a pneumatic classifier which is mounted on the lower part of the chamber.

16. The apparatus according to claim 14, wherein the ratio of the diameter to the height of the granulator chamber is about 1:2.5.

17. The apparatus according to claim 14, further comprising:
an exhaust pipe connected with the solids separation system; and
a filter disposed on an end of the exhaust pipe, wherein the exhaust pipe and a filter are configured to exhaust a gas used to separate the solid particles in the solids separation system.
